(19) United States
(12) Patent Application Publication
(10) Pub. No.: US 2016/0178856 A1
(43) Pub. Date: Jun. 23, 2016

(54) ENGAGING ASSEMBLY FOR SMALL FORM-FACTOR PLUGGABLE TRANSCEIVER

(71) Applicant: ACCTON TECHNOLOGY CORPORATION, Hsinchu (TW)

(72) Inventors: Wei-Lun Chang, Kaohsiung City (TW); Yin-Lung Chang, Hsinchu City (TW)

(21) Appl. No.: 14/978,124

(22) Filed: Dec. 22, 2015

Related U.S. Application Data
(60) Provisional application No. 62/095,471, filed on Dec. 22, 2014.

(51) Int. Cl. G02B 6/38; G02B 6/42

(52) U.S. Cl. CPC G02B 6/3893; G02B 6/4246; G02B 6/4284; G02B 6/3821

(57) ABSTRACT

An engaging assembly includes a housing, which has a recess provided on an outer surface thereof, and a slide member movably provided on the housing. The recess has a protrusion and a pushing portion provided in, wherein the protrusion extends out of the outer surface. After the engaging assembly is inserted into a base of an electronic device, the protrusion is in a securing hole of an elastic piece of the base, which prevents the engaging assembly from being disengaged from the base. The slide member has at least one extension arm located beside the protrusion. When the slide member is moved, an end of the extension arm is pushed by the pushing portion, so that the end projecting from the outer surface for a greater height than the protrusion does. The end then pushes the elastic piece to allow the engaging assembly to be disengaged from the base.

The current application claims a priority to U.S. provisional application No. 62/095,471 filed on Dec. 22, 2014.

### BACKGROUND OF THE INVENTION

1. Technical Field

The present invention relates generally to a small form-factor pluggable transceiver (SFP transceiver), and more particularly to an engaging assembly for a SFP transceiver.

2. Description of Related Art

Typically, a fiber-optic communication system includes two electronic devices and an optical fiber connecting both of the electronic devices, wherein the optical fiber transmits optical signals as the medium of information communication between the electronic devices, and has several advantages including high bandwidth, high speed, and better security.

While taking the size and occupied space of the electronic devices into consideration, each of the electronic devices usually adopts a small form-factor pluggable (SFP) transceiver inserted into a base thereof to connect the optical fiber, wherein the SFP transceiver bi-directionally converts optical signals into and from electrical signals. Since the SFP transceiver is a key component for connecting each electronic device to the optical fiber, it has to ensure that the transceiver is firmly connected to the base of the relevant electronic device while the optical fiber is being inserted into the transceiver. Therefore, designing an effective and simple way to firmly fix a transceiver on the base of an electronic device is an objective for manufactures of transceivers.

### BRIEF SUMMARY OF THE INVENTION

In view of the above, the primary objective of the present invention is to provide an engaging assembly, which can be effectively fixed on the base of an electronic device, and is easy to be pulled out.

The present invention provides an engaging assembly which receives a conversion circuit therein. The engaging assembly comprises a housing and a slide member. The housing accommodates the conversion circuit, wherein the housing has an outer surface, on which a recess is formed; the recess has a protrusion and a pushing portion provided therein, and the protrusion extends over the outer surface. The slide member is provided on the housing, wherein the slide member is movable between a first position and a second position relative to the housing; the slide member has at least one extension arm, which is located beside the protrusion; the at least one extension arm has a body and an end, wherein a thickness of the end is greater than a thickness of the body; when the slide member is at the first position, at least a part of the end is in the recess; when the slide member is at the second position, the end is pushed by the pushing portion, so that a height for the end projecting from the outer surface is greater than a height for the protrusion projecting from the outer surface.

With such design, after the engaging assembly being inserted into the base of the electronic device, the protrusion extending out of the housing engages with the securing hole of the base, which prevents the engaging assembly from being disengaged from the base. Furthermore, when the slide member is applied with force and moved to the second position, the thicker end of the extension arm pushes the elastic piece of the base, which makes the protrusion leave the securing hole to allow the engaging assembly to be pulled out from the base.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of a transceiver which has an engaging assembly of a preferred embodiment of the present invention applied therein;

FIG. 2 is a perspective view of the preferred embodiment of the present invention, showing another perspective;

FIG. 3 is a exploded view of the preferred embodiment of the present invention;

FIG. 4 is a sectional view of the preferred embodiment of the present invention along the A-A line in FIG. 1;

FIG. 5 is a perspective view of the first case of the preferred embodiment of the present invention;

FIG. 6 is a perspective view of the second case of the preferred embodiment of the present invention;

FIG. 7 is a perspective view of the slide member of the preferred embodiment of the present invention;

FIG. 8 is a bottom view of the slide member of the preferred embodiment of the present invention;

FIG. 9 is a perspective view of the elastic member of the preferred embodiment of the present invention;

FIG. 10 is a schematic view, showing the transceiver is connect to the base;

FIG. 11 is a schematic view, showing that the elastic member is located in the receiving depression when the slide member is at the first position;

FIG. 12 is a schematic view, showing the pull ring is flipped upward;

FIG. 13 is a schematic view, showing the slide member is at the second position;

FIG. 14 is a schematic view, showing that the elastic member is pressed and deformed in the receiving depression when the slide member is at the second position; and

FIG. 15 is a schematic view, showing the transceiver is pulled outwardly.

### DETAILED DESCRIPTION OF THE INVENTION

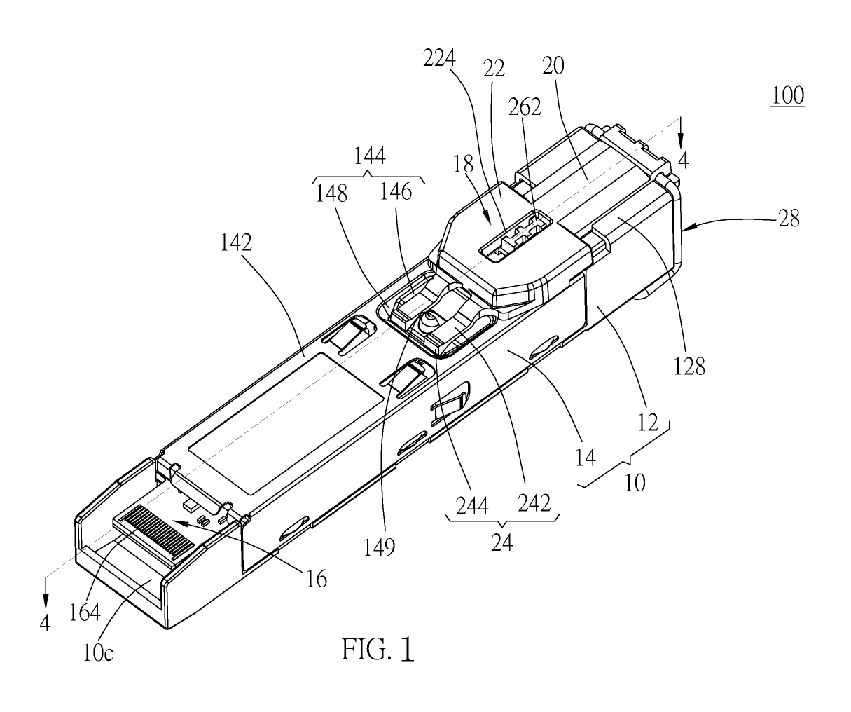

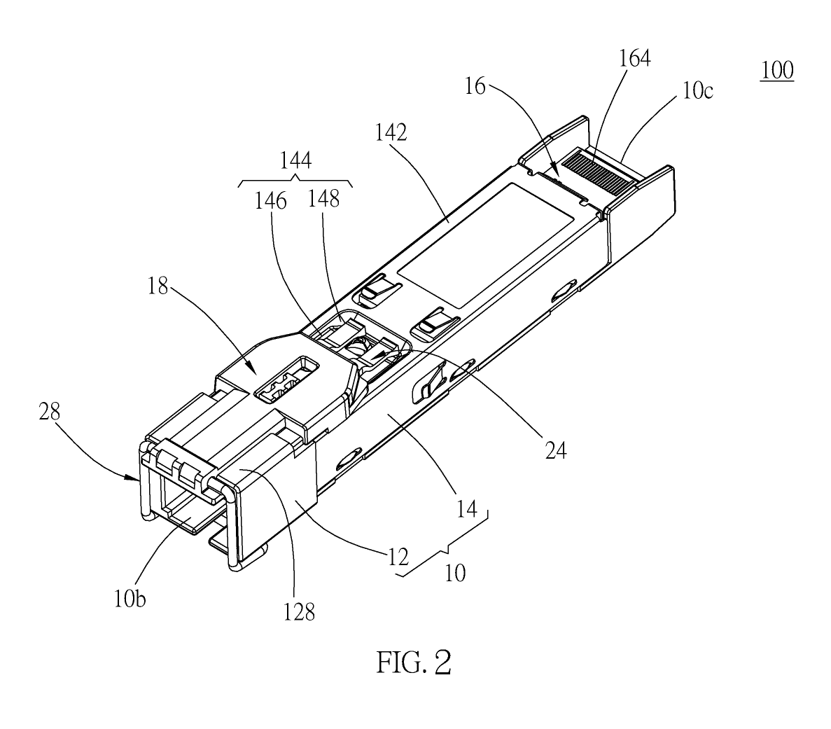

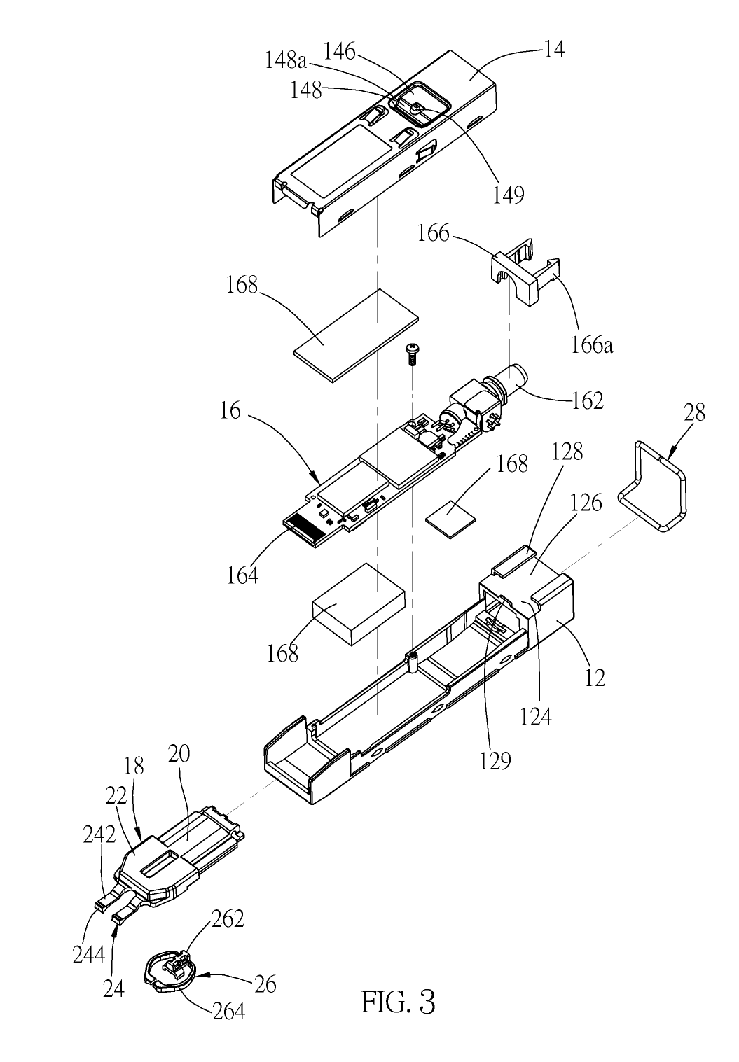

As shown in FIG. 1 to FIG. 4 and FIG. 9, a small form-factor pluggable transceiver (SFP transceiver) 100 includes a conversion circuit 16 and an engaging assembly of a preferred embodiment of the present invention, wherein the engaging assembly includes a housing 10, a slide member 18, an elastic member 26, and a pull ring 28.

The housing 10 appears like a cuboid, and includes a first case 12 and a second case 14, wherein the first case 12 and the second case 14 are combined together to form a chamber 10a therebetween to accommodate the conversion circuit 16. The housing 10 has a first open end 10b and a second open end 10c at opposite ends thereof, which both communicate with the chamber 10a. The first case 12 has a passageway 122 communicating with the first open end 10b and the chamber 10a.

The conversion circuit 16 is installed in the chamber 10a, and has an optical transceiving terminal 162 and an electric transceiving terminal 164. The conversion circuit 16 converts optical signals received through the optical transceiving terminal 162 into electric signals, and then outputs the electric signals through the electric transceiving terminal 164. Similarly, the conversion circuit 16 also converts electric signals received through the electric transceiving terminal 164 into optical signals, and then outputs the optical signals through the optical transceiving terminal 162. A part of the optical transceiving terminal 162 extends into the passageway 122 of the first case 12, while the electric transceiving terminal 164 is located near the second open end 10c. The first open end 10b of the first case 12 allows an optical fiber connector (not shown) to be inserted therein to connect the optical transceiving terminal 162, while the electric transceiving terminal 164 is used to be inserted into a connecting slot (not shown). In addition, the optical transceiving terminal 162 is provided with a connector holder 166 thereon, which is received in the chamber 10a. The connector holder 166 has two hooks 166a extending into the passageway 122 to firmly engage the optical fiber connector to the optical transceiving terminal 162. A plurality of heat sinks 168 are further provided in the chamber 10a to contact electronic components on the conversion circuit 16 and the housing 10 at the same time. In this way, heat generated by the electronic components of the conversion circuit 16 can be conducted to the housing 10.

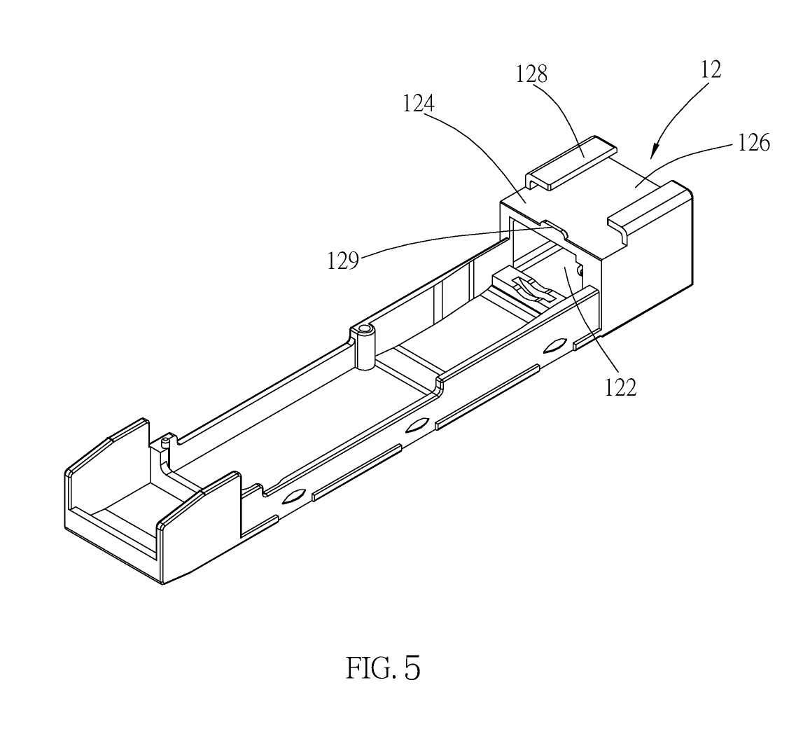

As shown in FIG. 5, the first case 12 has an engaging groove 126 on a side wall 124 near the first open end 10b. The engaging groove 126 extends along a long axis of the housing 10 to form a track, which engages with the slide member 18 and guides the slide member 18 to move therein. In the preferred embodiment, the engaging groove 126 is formed by being surrounded by two bending plates 128 connected to the side wall 124. In addition, the side wall 124 has a convex portion 129 at a location opposite to the first open end 10b, wherein the convex portion 129 is on a moving path of the slide member 18.

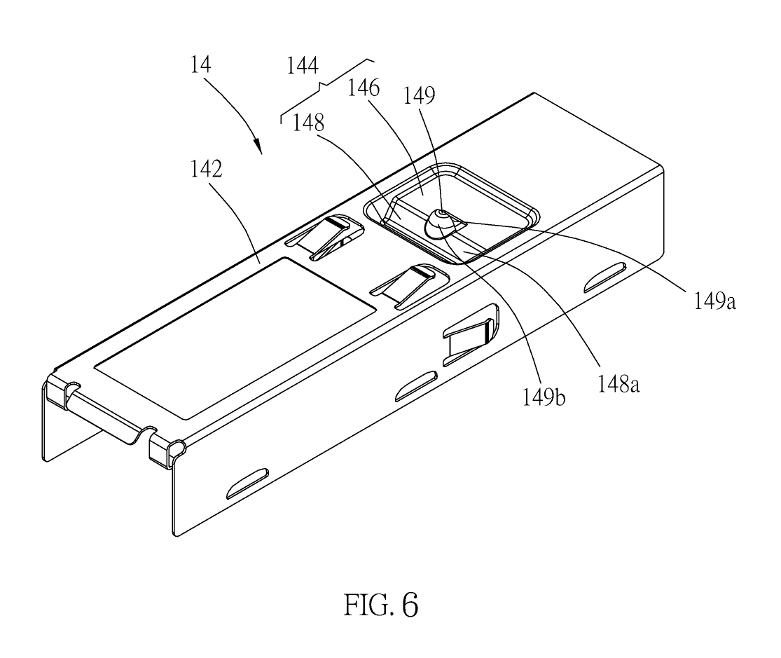

As shown in FIG. 6, the second case 14 has a recess 144 formed on an outer surface 142 near the side wall 124 of the first case 12, wherein the recess 144 includes a first notch 146 and a second notch 148 which communicate with each other. The first notch 146 is located between the second notch 148 and the convex portion 129 of the first case 12. A depth of the second notch 148 is greater than that of the first notch 146. The second notch 148 has a pushing portion, which is an inclined plane 148a as an example, wherein the inclined plane 148a slopes downward from where the first notch 146 meets the second notch 148 toward the second open end 10c to form the second notch 148 which has the greater depth. The second case 14 has a protrusion 149 located at where the first notch 146 meets the second notch 148, wherein the protrusion 149 extends upward to be higher than the outer surface 142. The protrusion 149 has a flat portion 149a facing the first open end 10b, and a curved portion 149b facing the second open end 10c.

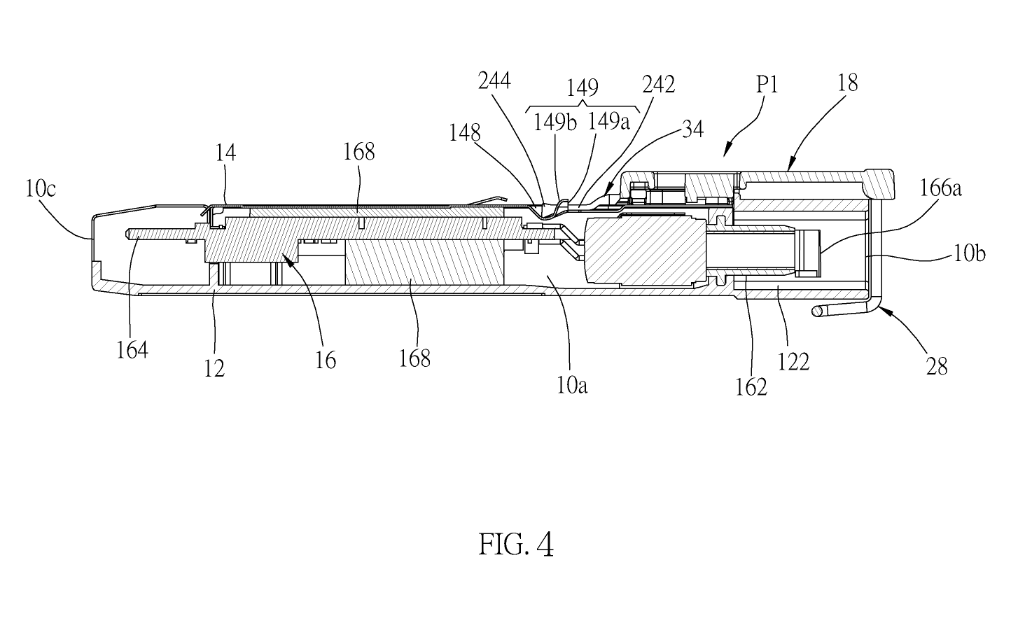

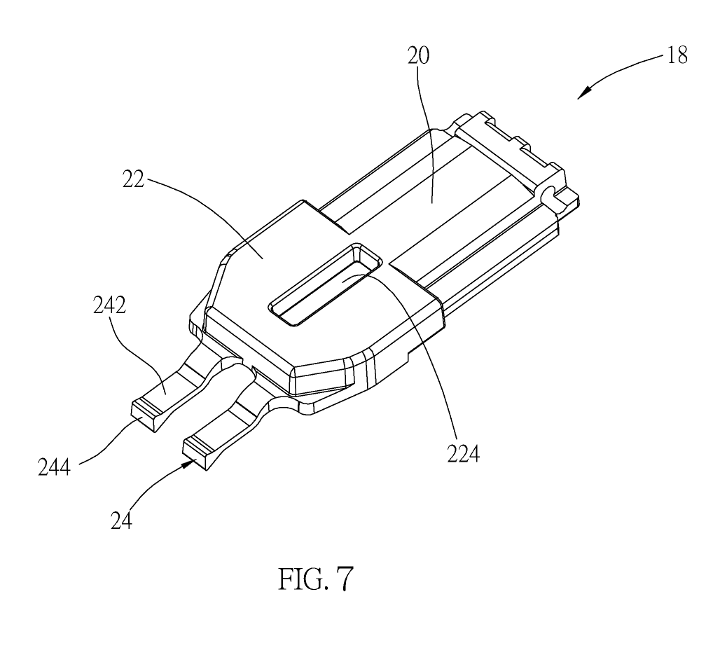

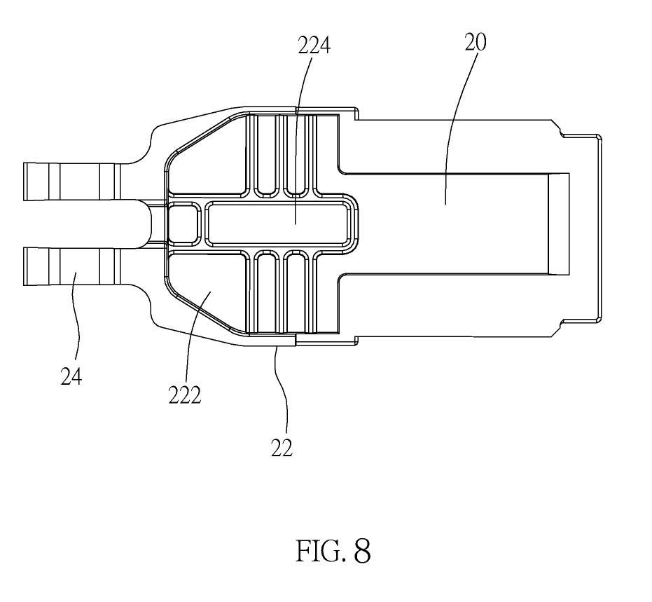

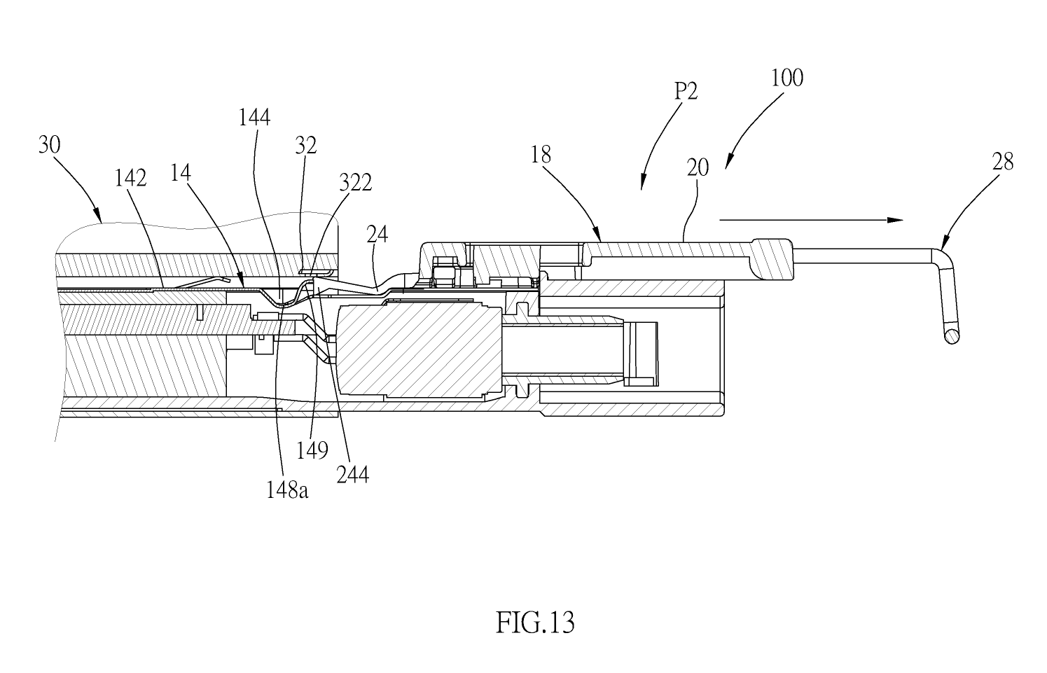

As shown in FIG. 7 and FIG. 8, the slide member 18 includes a slide block 20 and a stop block 22 which are connected to each other. The slide block 20 can be inserted into the engaging groove 126 to be confined by the bending plates 128. In this way, the slide member 18 can be moved straightly in an extending direction of the engaging groove 126. The stop block 22 is wider than the engaging groove 126, and therefore a movable distance of the slide member 18 is limited since the stop block 22 would push against the bending plates 128 once the slide member 18 is moved toward the first open end 10b for a certain distance. Whereby, if applied with force, the slide member 18 can be moved relative to the housing between a first position P1 as shown in FIG. 4 and a second position P2 as shown in FIG. 13.

The stop block 22 has a receiving depression 222 and an elongated slit 224, wherein the receiving depression 222 is concaved from a lower surface of the stop block 22, and the slit 224 goes through a surface of the receiving depression 222 and an upper surface of the stop block 22, wherein a long axial of the slit 224 extends in a moving direction of the slide member 18. At least one elastic extension arm 24 extends out from the stop block 22, wherein the number of the elastic extension arm 24 is more than one in the current preferred embodiment, and each of the extension arms 24 has a body 242 and an end 244. A thickness of the end 244 is greater than that of the body 242, and a thickness of each of the extension arms 24 is gradually increased from the body 242 toward the end 244. The extension arms 24 are received in the recess 144 of the second case 14 with the protrusion 149 located therebetween. When the slide member 18 is at the first position P1, each of the bodies 242 is in the first notch 146, and each of the ends 244 has at least a part thereof located in the second notch 148 to abut against the inclined plane 148a.

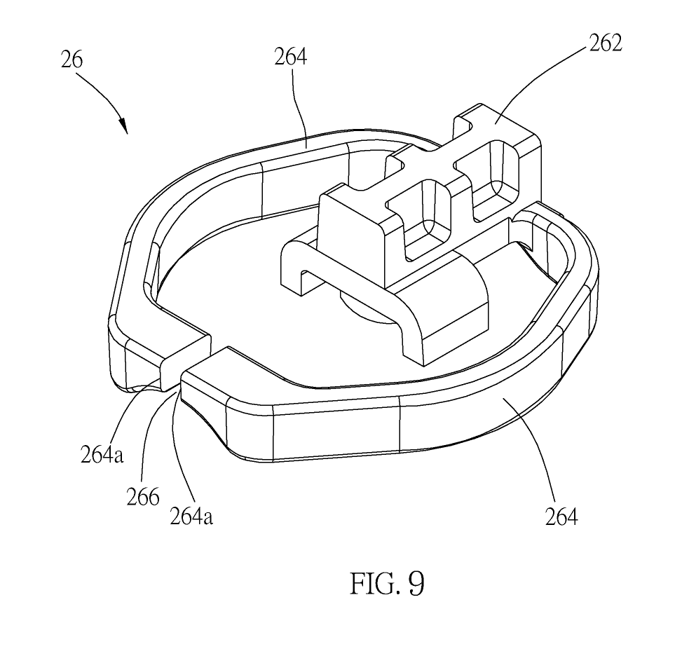

As shown in FIG. 9, the elastic member 26 is provided in the receiving depression 222 of the slide member 18, wherein the elastic member 26 has a guide block 262 and two elastic arms 264. The guide block 262 extends into the slit 224 of the slide member 18. The elastic arms 264 are connected to two opposite sides of the guide block 262, wherein the elastic arms 264 are curved in shape to correspond to the receiving depression 222. Each of the elastic arms 264 has a free end 264a, wherein a gap 266 is formed between the free ends 264a. The elastic arms 264 are elastically deformed when applied with force, and the gap 266 additionally provides more space for deformation for the elastic arms 264. Once the elastic arms 264 have no force applied thereto, they are automatically restored back to the original status.

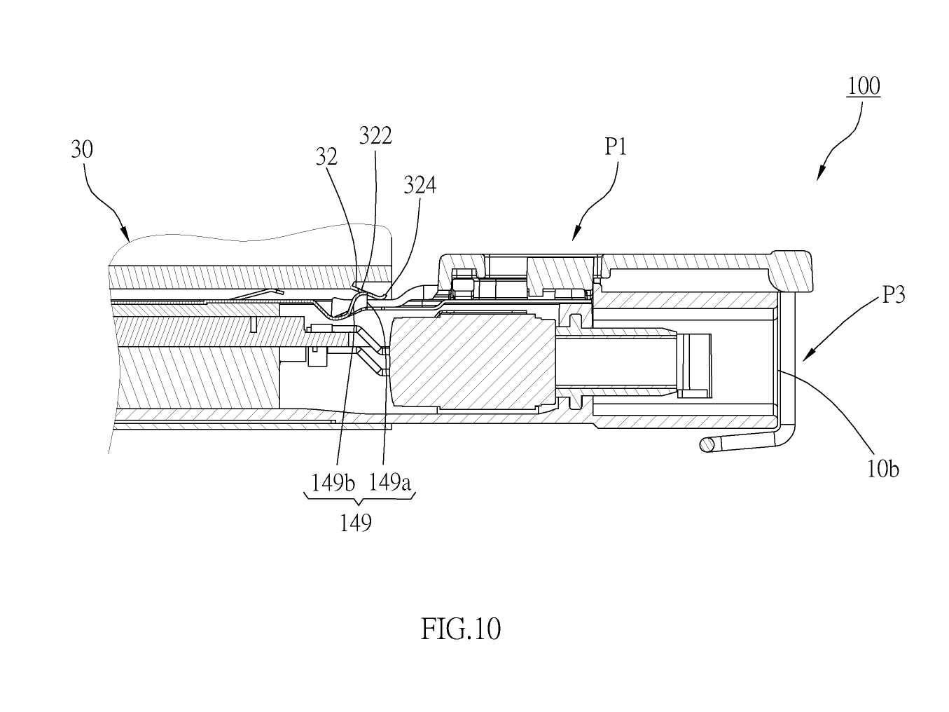

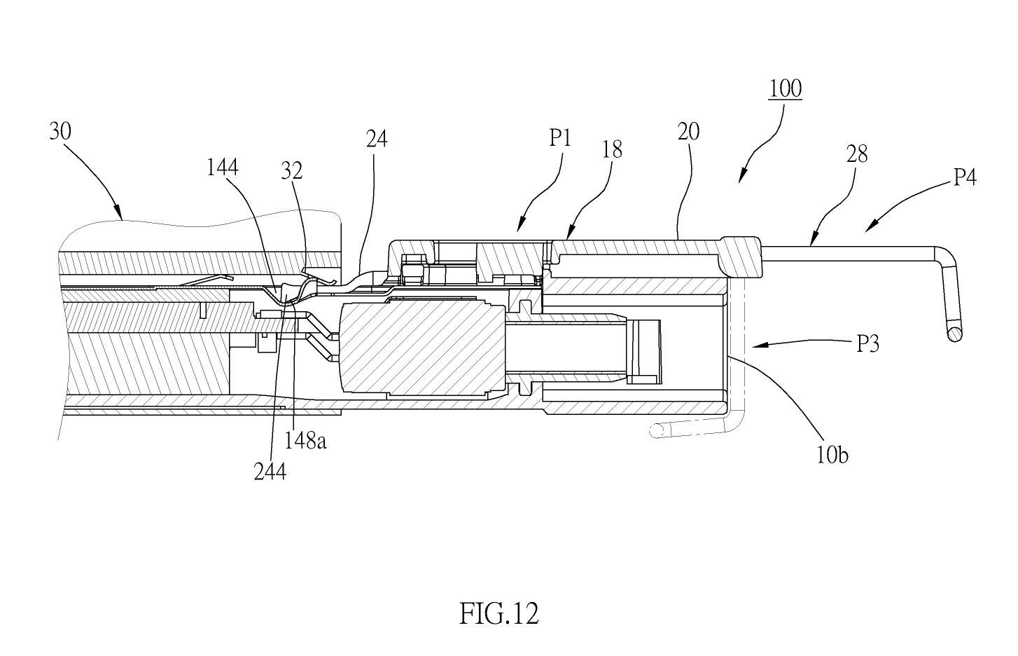

The pull ring 28 is pivotally provided on the slide block 20 of the slide member 18 for a user to pull the slide member 18. The pull ring 28 can be pulled to move the slide block 20, and the slide member 18 is consequently moved toward the first open end 10b and the second position P2. The pull ring 28 is pivotable between a third position P3 shown in FIG. 10 and a fourth position P4 shown in FIG. 12. When the pull ring 28 is at the third position P3, the pull ring 28 abuts on a margin of the first open end 10b and gets fixedly received; when the pull ring 28 is at the fourth position P4, the pull ring 28 is away from the margin of the first open end 10b, and therefore is ready to be pulled by a user.

As shown in FIG. 10, the SFP transceiver 100 is engaged with a base 30 of an electronic device while operating. The base 30 has an elastic piece 32 therein, wherein the elastic piece 32 has a securing hole 322, or a corresponding recess, thereon. After the engaging assembly of the SFP transceiver 100 is inserted into the base 30, the curved portion 149b of the protrusion 149 of the second case 14 pushes a bending portion 324 located at a distal end of the elastic piece 32 upward, which makes the protrusion 149 get into the securing hole 322 along a lower surface of the elastic piece 32. And then, the elastic piece 32 is stuck by the protrusion 149, and since the flat portion 149a of the protrusion 149 contacts an edge of the securing hole 322, the SFP transceiver 100 cannot be disengaged with the base 30. As shown in 11, an end of the guide block 262 of the elastic member 26 abuts against the convex portion 129 at the same time. As a result, the elastic arms 264 are forced to push against a wall of the receiving depression 222, which keeps the slide member 18 staying at the first position P1.

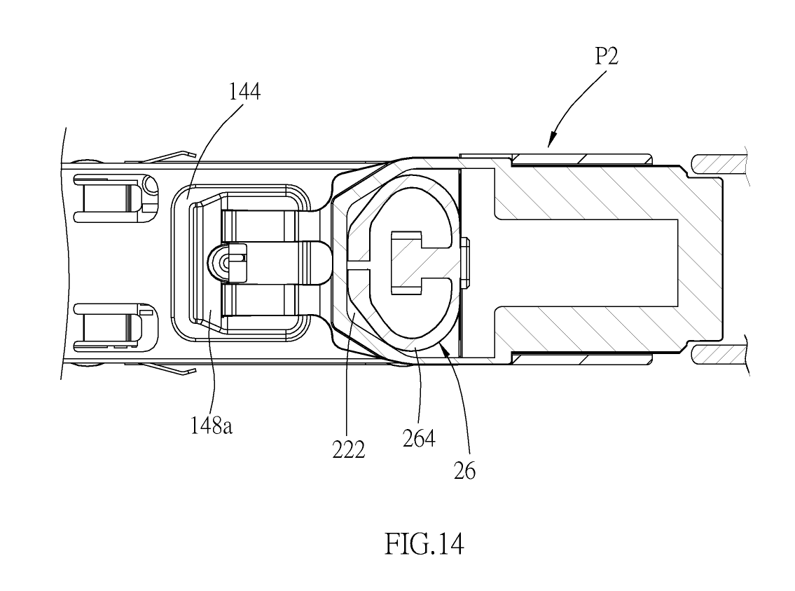

As shown in FIG. 12 and FIG. 13, if a user intends to remove the SFP transceiver 100, the pull ring 28 is lifted upward and then pulled outwardly. While being pulled out, the slide block 20 of the slide member 18 is brought by the pull ring 28 to move along the engaging groove 126. During the process of moving the slide member 18 from the first position P1 to the second position P2, the ends 244 of the extension arms 24 are pushed upwardly along and by the inclined plane 148a inside the recess 144. Consequently, the elastic piece 32 of the base 30 is pushed by the ends 244. At the same time, the elastic arms 264 of the elastic member 26 are elastically deformed because the wall of the receiving depression 222 applies a compression force thereto, but meanwhile, the guide block 262 abuts against the convex portion 129 and therefore is unmovable (as shown in FIG. 14). When the slide member 18 is moved to the second position P2, a height for the ends 244 of the extension arms 24 projecting from the outer surface 142 of the second case 14 along the inclined plane 148a is greater than a height for the protrusion 149 projecting from the outer surface 142, and the ends 244 of the extension arms 24 push the elastic piece 32, so that the securing hole 322 of the elastic piece 32 detaches from the protrusion 149.

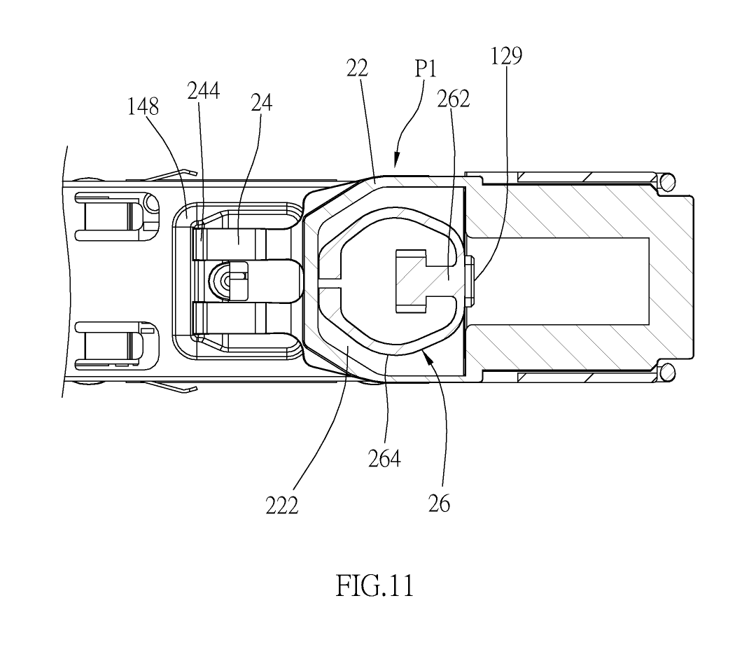

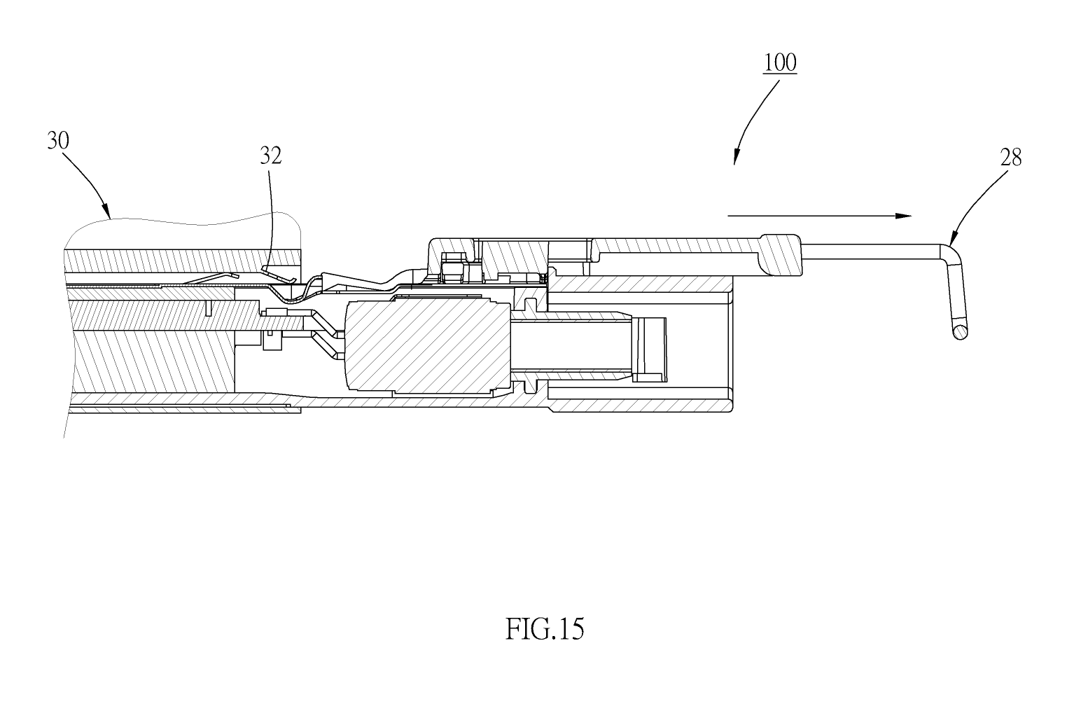

As shown in FIG. 15, the SFP transceiver 100 then can be continuously pulled out from the base 30. Once the pull ring 28 is released, the elastic arms 264 of the elastic member 26 are elastically restored to the status illustrated in FIG. 11 and push against the wall of the receiving depression 222. Therefore, the slide member 18 returns to the first position P1; the ends 244 of the extension arms 24 return into the second notch 148 as well.

While the slide member 18 is being moved, the guide block 262 of the elastic member 26 always stays at the same location. Hence, with the limitation provided by the guide block 262 and the slit 224 of the slide member 18 together, the slide member 18 is avoided from being moved laterally, which makes the movement of the slide member 18 further smooth. In addition of using the inclined plane 148a as the pushing portion, the recess 144 can be also designed to have a protrusion provided therein, which makes the ends 244 of the extension arms 24 be pushed upwardly by the protrusion while the slide member 18 is being moved.

It must be pointed out that the embodiment described above is only one preferred embodiment of the present invention. The base 30 of the electronic device and the conversion circuit 16 are merely components or structures used for explaining the engaging assembly of the present invention, and therefore are not limitations of the present invention. All equivalent structures which employ the concepts disclosed in this specification and the appended claims should fall within the scope of the present invention.

What is claimed is:

1. An engaging assembly, which receives a conversion circuit therein; comprising:
a housing accommodating the conversion circuit, wherein the housing has an outer surface, on which a recess is formed; the recess has a protrusion and a pushing portion provided therein, and the protrusion extends over the outer surface; and
a slide member provided on the housing, wherein the slide member is movable between a first position and a second position relative to the housing; the slide member has at least one extension arm, which is located beside the protrusion; the at least one extension arm has a body and an end, wherein a thickness of the end is greater than a thickness of the body; when the slide member is at the first position, at least a part of the end is in the recess; when the slide member is at the second position, the end is pushed by the pushing portion, so that a height for the end projecting from the outer surface is greater than a height for the protrusion projecting from the outer surface.

2. The engaging assembly of claim 1, wherein the recess has a inclined plane provided therein; the inclined plane forms the pushing portion; while the slide member is being moved from the first position to the second position, the end of the at least one extension arm is pushed by the inclined plane, and is moved along the inclined plane.

3. The engaging assembly of claim 2, wherein the recess comprises a first notch and a second notch which are connected to each other; a depth of the second notch is greater than a depth of the first notch; the protrusion is formed at where the first notch meets the second notch; the second notch has the inclined plane provided therein; when the slide member is at the first position, the body is in the first notch, and the end is in the second notch.

4. The engaging assembly of claim 1, further comprising an elastic member, wherein the slide member further has a receiving depression, in which the elastic member is provided; while the slide member is moved from the first position to the second position, the housing and a wall of the receiving depression applies a compression force to the elastic member, which is therefore elastically deformed; once the compression force releases, the elastic member is elastically restored to an original status to push the wall of the receiving depression, so that the slide member is moved to the first position.

5. The engaging assembly of claim 4, wherein the elastic member has two elastic arms, which are curved in shape to correspond the wall of the receiving depression; each of the elastic arms respectively has a free end, wherein a gap is formed between the free ends; the elastic arms are elastically deformed if provided with the compression force from the housing and the wall of the receiving depression.

6. The engaging assembly of claim 5, wherein the slide member has an elongated slit, which communicates with the receiving depression; the elastic member has a guide block extending into the slit; a long axial of the slit extends in a moving direction of the slide member.

7. The engaging assembly of claim 6, wherein the housing has an engaging groove; the slide member comprises a slide block and a stop block, wherein the slide block is movably provided in the engaging groove, and the stop block has the receiving depression and the slit provided thereon; the at least one extension arm is connected to the stop block.

8. The engaging assembly of claim 7, wherein the stop block has a upper surface and a lower surface; the receiving depression is formed on the lower surface; the slit extends through the wall of the receiving depression and the upper surface.

9. The engaging assembly of claim 6, wherein the housing has a convex portion provided on a moving path of the slide member; the elastic arms are respectively connected to one of two opposite sides of the guide block; while the slide member is moved from the first position to the second position, the elastic arms of the elastic member abut against the wall of the receiving depression, and the guide block abuts against the convex portion of the housing, so that the elastic member is compressed and therefore elastically deformed.

10. The engaging assembly of claim 1, further comprising a pull ring pivotally provided on the slide member, wherein the pull ring is adapted to be pulled to move the slide member toward the second position; the pull ring is adapted to pivot between a third position and a fourth position; the housing has an open end, wherein when the pull ring is at the third position, the pull ring abuts on a margin of the open end; when the pull ring is at the fourth position, the pull ring is away from the margin of the open end.
